(19) United States
(12) Patent Application Publication
(10) Pub. No.: US 2008/0301148 A1
(43) Pub. Date: Dec. 4, 2008

(54) METHODS AND APPARATUS RELATING TO SERVER/CLIENT SQL ENVIRONMENTS

(75) Inventors: Il-Sung Lee, Seattle, WA (US); Matthew A. Neerincx, Bellevue, WA (US); Vaughn L. Washington, Seattle, WA (US); Alazel Acheson, Redmond, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/767,556

(22) Filed: Jun. 25, 2007

Related U.S. Application Data
(60) Provisional application No. 60/941,570, filed on Jun. 1, 2007.

(51) Int. Cl. G06F 17/30; G06F 3/00

(52) U.S. Cl. 707/10; 710/30; 707/E17.032

(57) ABSTRACT

Systems and methodologies that enhance a Tabular Data Stream (TDS) protocol by enabling clients to send tabular formed data as a single parameter to servers. A Table Valued Parameter (TVP) transporting component enables the client servers to transmit entire database tables as a single parameter; when invoking a server side procedure, for example. As such, values can be passed for functions associated with a stored procedure, and a parameter styled Application Program Interface (API) can be implemented.

### CROSS REFERENCE TO RELATED APPLICATION

This application claims the benefit of U.S. Provisional Application Ser. No. 60/941,570 entitled “METHODS AND APPARATUS RELATING TO SERVER/CLIENT SQL ENVIRONMENTS”, filed on Jun. 1, 2007, the entirety of which is herein incorporated by reference.

### BACKGROUND

Advances in computer technology (e.g., microprocessor speed, memory capacity, data transfer bandwidth, software functionality . . . ) have generally contributed to increased computer application in various industries, such that organization of computer systems has changed dramatically. The concept of a large computer center with a single large computer to which all users bring their work is obsolete. Similarly, Data Base Management Systems (DBMS systems) have long since moved from a centralized mainframe environment to a de-centralized or distributed environment. For example, one or more PC “client” systems can be connected via a network to one or more server-based database systems (Structure Query Language—SQL database server). Known examples of computer networks include local-area networks (LANs) where the computers are geographically close together (e.g., in the same building), and wide-area networks (WANs) where the computers are farther apart and are connected by telephone lines or radio waves.

Often, networks are configured as “client/server” networks, such that computers on the network classify as a “client” or a “server.” Servers are powerful computers or processes dedicated to managing shared resources, such as storage (e.g. disk drives), printers, modems, or the like. Servers are often dedicated, meaning that they perform virtually no other tasks besides their server tasks. For instance, a database server manages database information such as processing database queries from various clients. The client portion of client-server architecture typically includes PCs or workstations, which rely on server(s) to perform operations. Typically, a client runs a “client application” that relies on a server to perform some operations, such as returning particular database information. Over such networks, various request-response protocols transport information according to predetermined set of rules.

One such request-response protocol is the Tabular Data Stream (TDS) protocol, which is a message oriented application level protocol employed for transfer of requests and responses between client and server systems. TDS can include native support for traditional SQL data types, such as character (char), variable-length character (vchar), binary (blob), date-time, time stamp, vendor-specific data types, and the like. In systems employing TDS, it is typical for a client (e.g., user or application program) to establish a long-lived connection with a server (e.g., database.) Upon a successful hand shake and establishment of the connection via a suitable supported transport/session level protocol, a complete message transfers from client to server after which a complete response travels from server to client.

### SUMMARY

The following presents a simplified summary of the specification in order to provide a basic understanding of some aspects of the specification. This summary is not an extensive overview of the specification. It is intended to neither identify key or critical elements of the specification nor delineate the scope of the specification. Its sole purpose is to present some concepts of the specification in a simplified form as a prelude to the more detailed description that is presented later.

The subject innovation enhances a Tabular Data Stream (TDS) protocol by enabling clients to send tabular formed data as a single parameter to servers (e.g., sending tables inside of a parameter to SQL servers). Such TDS protocol can employ a Table Valued Parameter (TVP) transporting component that allows client servers to transmit entire database tables as a single parameter when invoking a server side procedure(s), for example. As such, values can be passed for functions associated with a stored procedure, and a parameter styled Application Program Interface (API) can be implemented; wherein the server can also send output parameters or return values to the client by employing the TVP type that can encapsulate entire tables of data.

Accordingly, as opposed to merely sending individual values as parameters; a table shaped set of values can be sent as a single parameter from a client to a server. Hence, a client can send data in from of “N” number of columns and “M” number of rows (where M, N are integers) as a single parameter to a server. Likewise, such single parameter can be treated as a single entity on the server side. In a related aspect, the TVP transporting component employs metadata associated with the tabular form that is sent as a single parameter to the server. Such can include a syntax form that designates data types/strings, number of rows, number of columns, and the like

According to a methodology of the subject innovation, metadata associated with defining a table can initially be designated, in a syntax form, such as setting flags to indicate nullable types and the like. Subsequently, the tabular shaped data forms can be sent as a single parameter to a server from a client. Next, the server can treat such single parameter as a single entity. Associated queries can then be executed on the server side.

To the accomplishment of the foregoing and related ends, the innovation, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 illustrates an exemplary Tabular Data Stream (TDS) protocol that enables sending table shaped set of values as a single parameter from a client to a server, according to an aspect of the subject innovation.

FIG. 2 illustrates a Table Valued Parameter (TVP) transporting component as part of the TDS protocol of the subject innovation.

FIG. 3 illustrates a particular example of TVP format for three parameters in accordance with an aspect of the subject specification.

FIG. 4 illustrates a methodology of sending tabular formed data as a single parameter to servers in accordance with an aspect of the subject innovation.

FIG. 5 illustrates a related methodology of encapsulating tables of data via a TVP transporting component of the subject innovation.

FIG. 6 illustrates an exemplary buffer header arrangement as part of a TVP transporting component that allows client servers to transmit entire database tables as a single parameter.

FIG. 7 illustrates an artificial intelligence (AI) component associated with the TVP component, in accordance with a particular aspect of the subject innovation.

FIG. 8 illustrates an exemplary system that implements an enhanced TDS protocol according to a further aspect of the subject innovation.

FIG. 9 illustrates an exemplary environment for implementing various aspects of the subject innovation.

FIG. 10 is a schematic block diagram of a sample-computing environment that can be employed for transfer of tabular data according to an aspect of the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

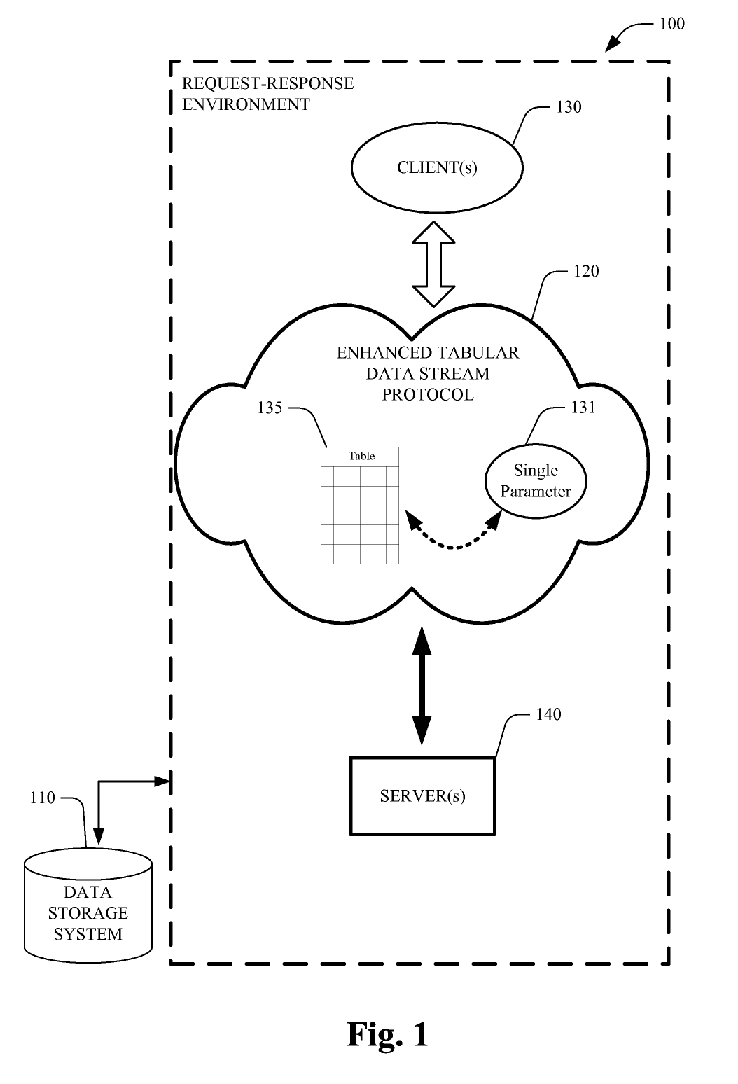

FIG. 1 illustrates a block diagram for a system 100 that employs an enhanced Tabular Data Stream (TDS) protocol 120 in accordance with an aspect of the subject innovation. Such enhanced TDS protocol enables the client 130 to send an entire data base table 135 in form of a single parameter 131 to the server 140, wherein statements can subsequently be executed and results sent back to the client 130.

The system 100 is associated with a data storage system 110, which can be a complex model based database structure, wherein an item, a sub-item, a property, and a relationship are defined to allow representation of information within a data storage system as instances of complex types. For example, the data storage system 110 can employ a set of basic building blocks for creating and managing rich, persisted objects and links between objects. An item can be defined as the smallest unit of consistency within the data storage system 110, which can be independently secured, serialized, synchronized, copied, backup/restored, and the like. Such item can include an instance of a type, wherein all items in the data storage system 110 can be stored in a single global extent of items. Furthermore, the data storage system 110 can be based upon at least one item and/or a container structure, and can act as a storage platform exposing rich metadata that is buried in files as items. The data storage system 110 can include the database (not shown), to support the above discussed functionality, wherein any suitable characteristics and/or attributes can be implemented. Furthermore, the data storage system 110 can employ a container hierarchical structure, wherein a container is an item that can contain at least one other item. Such containment concept can be implemented via a container ID property inside the associated class, wherein the store can also be a container in form of a physical organizational and manageability unit. In addition, the store represents a root container for a tree of containers within the hierarchical structure. As illustrated in FIG. 1, the enhanced TDS 120 allows table shaped set of values to be sent as a single parameter from the client 130 to the server 140—as opposed to merely sending individual values as parameter. Hence, the client 130 can send data in form of “N” number of columns and “M” number of rows (where M, N are integers) as a single parameter to the server 140.

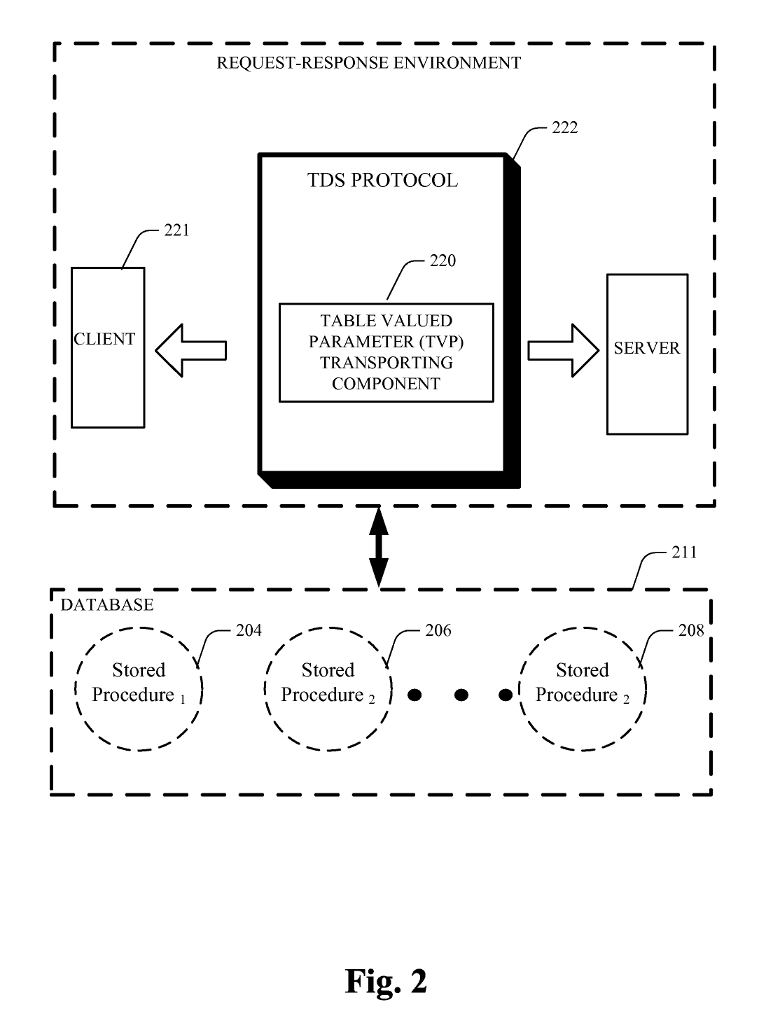

FIG. 2 illustrates a Table Valued Parameter (TVP) transporting component 220 as part of the TDS protocol 222, in accordance with an aspect of the subject innovation. For example, when invoking a sever side procedure, the TVP transporting component 220 enables the client 221 to transmit entire database tables as a single parameter, when invoking a server side procedure, and values can be passed for functions associated with a stored procedure, for example.

Typically, the stored procedures 204, 206, 208 (1 thru m, where m is an integer) are programs (or procedures) that are physically stored within the database. Such programs are usually written in a proprietary database language and in response to a user request, run directly by an engine of the database 211.

The stored procedures 204, 206, 208 can have direct access to the data that requires manipulation, and typically need only send results back to the user, thus mitigating the overhead of communicating large amounts of data back and forth. For example, typical uses for stored procedures 204, 206, 208 can include data validation, which is integrated into the database structure (stored procedures used for this purpose are often called triggers), or encapsulating some large or complex processing (such as manipulating a large dataset to produce a summarized result). Stored procedures 204, 206, 208 can also be employed when the database 211 is manipulated from many external programs. The TVP transporting component 220 allows a parameter styled Application Program Interface (API) to be implemented; wherein the server can also send output parameters or return values to the client using the TVP type, which can encapsulate entire tables of data.

The following discussion describes a particular aspect of the TVP transporting component 220 in accordance with an aspect of the subject innovation. For example, considering the following table definition;
“create table authors(aid int primary key, aname varchar(max))”
   a customer can then define a stored procedure with an “tvp_authors” table valued parameter, allowing caller to pass in a table with 0. . . N (where N is an integer) rows as a parameter and have the following inserted into the authors table:
create procedure proc_insert_authors(@p1 tvp_authors) as insert into authors select*from @p1

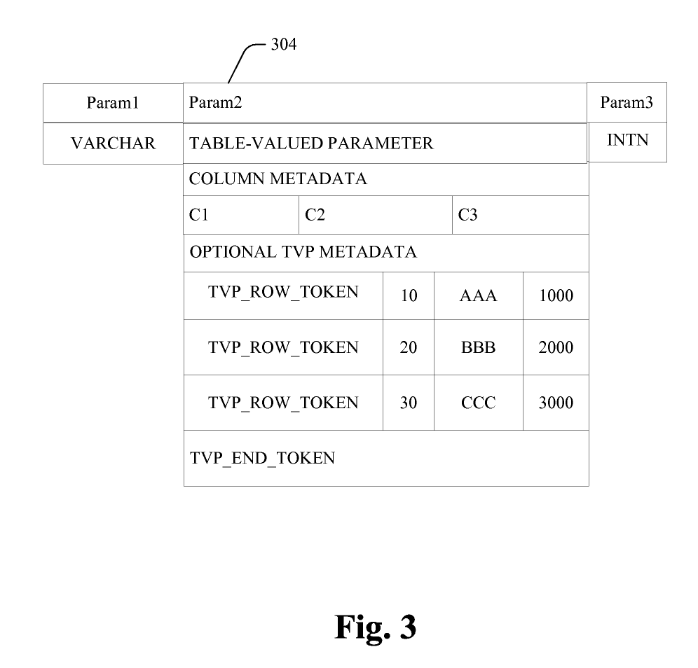

For the related TVP format, FIG. 3 illustrates a diagram for an incoming set of three parameters with the “Param 2” (304)as a TVP parameter. As such, the associated syntax can be in form of;

// Metadata grammar
//

| | |
|---|---|
| TVP_TYPE_INFO | := TVPTYPE, |

| TVP_TYPENAME, | // Type name |
|---|---|
| TVP_COLMETADATA, | // Column specific metadata |
| [TVP_ORDER_UNIQUE], // Optional metadata token | |
| [TVP_COLUMN_ORDERING], // Optional metadata token | |
| TVP_END_TOKEN, | // End optional metadata |
| {TVP_ROW}, | // 0..N TVP_ROW tokens |
| TVP_END_TOKEN | // End of rows |

// Metadata grammar components
//
TVPTYPE := 0xF3;
// TVP_TYPENAME definition
//

| | |
|---|---|
| DbName := | B_VARCHAR; // Database where TVP type resides |
| OwningSchema := | B_VARCHAR; // Schema where TVP type resides |
| TypeName := | B_VARCHAR; // TVP type name |

TVP_TYPENAME := DbName, OwningSchema, TypeName

In such syntax, DbName, OwningSchema, and TypeName can include up to 128 characters (128 WCHARs is the maximum identifier length), for example. It is to be appreciated that DbName can also be zero-length, and OwningSchema and TypeName can be specified. Such DbName, OwningSchema, and TypeName are optional fields and can contain zero length strings. Caller should typically follow the following, namely; if the TVP is a parameter to a stored procedure or function where parameter metadata is available on the server side, then the client can send all zero length strings for TVP_TYPENAME; and/or; if the TVP is a parameter to an adhoc SQL statement, parameter metadata information is typically not available on a stored procedure or function on the server, and if so the client is responsible to send sufficient type information with the TVP to allow the server to resolve the TVP type from sys.types, for example.

// TVP_COLMETADATA definition

| // | | |
|---|---|---|
| fNullable | := BIT; | // Column is nullable - 0x01 |
| fCaseSen | := BIT; | // Column is case-sensitive - |
| 0x02 | | |
| usUpdateable | := BIT, BIT; | // 2-bit value, one of: |
| | | // 0 = ReadOnly - 0x00 |
| | | // 1 = ReadWrite - 0x04 |
| | | // 2 = Unknown - 0x08 |
| fIdentity | := BIT; | // Column is identity column - |
| 0x10 | | |
| fComputed | := BIT; | // Column is computed - 0x20 |
| usReservedODBC | := BIT, BIT; | // Reserved bits for ODBC - |
| 0x40+80 | | |
| fFixedLenCLRType | := BIT; | // Fixed length CLR type - 0x100 |
| fDefault | := BIT; | // Column is default value - |
| 0x200 | | |
| usReserved | := BIT, BIT, | // Six leftover reserved bits. |
| | BIT, BIT, | |
| | BIT, BIT; | |
| Flags | := fNullable, fCaseSen, usUpdateable, | |
| | fIdentity, fComputed, usReservedODBC, | |
| | fFixedLenCLRType, fDefault, usReserved; | |
| Count | := USHORT; | // Column count up to 1024 max |
| ColName | := B_VARCHAR; | // Name of column |
| UserType | := ULONG; | // UserType of column |

| | |
|---|---|
| TvpColumnMetaData | := UserType, Flags, // Column metadata |
| instance | |
| | TYPE_INFO, ColName; |

| | |
|---|---|
| TVP_NULL_TOKEN | := 0xFFFF; |
| TVP_COLMETADATA | := TVP_NULL_TOKEN \| |
| | Count, { TvpColumnMetaData }; |

For the exemplary syntax above, typically, one new flag fDefault can be added, and if the fDefault flag is set, the client driver can skip emitting the column's data value when sending the TVP_ROW. Moreover, ColName is typically zero length within a TVP, and a user UserType can be ignored, unless where UserType=x_utypTimeStamp (0×50) and TYPE_INFO TDS type is BIGBINARY. If so, the client is indicating that the column is a TIMESTAMP column, and for such particular TIMESTAMP case, the client can flag the column as default, to avoid rejection of the TVP. It is to be appreciated that TvpColumnMetaData for TVP does not include TableName for TEXT, NTEXT, and IMAGE columns as with normal COLMETADATA token. Moreover, TVP_NULL_TOKEN token can be employed if the entire TVP parameter is a default value (e.g., employing the TVP_NULL_TOKEN if the parameter is not default will typically be rejected by the server).

Flag Usage in TVP

Typically, for an input TVP, if the fDefault flag is set on a column, then the client is required to not emit the corresponding TvpColumnData data for the associated column when sending each TVP_ROW. Such improves operation efficiency (e.g., to mitigate sending dummy or null data values), wherein the server inserts the missing value(s) on the server side when building the TVP table.

Likewise, for an input TVP, the fCaseSen, usUpdateable, and fFixedLenCLRType flags can be ignored. Moreover, fCaseSen can be calculated from collation, and the server ignores such value internally, hence the client driver is not burdened with associated calculations. In addition. usUpdateable is ignored by server on input, and the fFixedLenCLRType flag is not employed by server.

For output TVPs the Flags mirror the values send by a typical ColMetaData token in a resultset.

TABLE 1
TVP Flags Usage Chart

| Flag | Input Behavior | Output Behavior |
|---|---|---|
| fNullable | Allowed | Allowed |
| fCaseSen | Ignored | Allowed |
| usUpdateable | Ignored | Allowed |
| fIdentity | Allowed | Allowed |
| fComputed | Allowed | Allowed |
| usReservedODBC | Ignored | Ignored |
| fFixedLenCLRType | Ignored | Ignored |
| fDefault | Allowed (if set, data not | Ignored |
| | sent in TvpColumnData) | |
| usReserved | Ignored | Ignored |

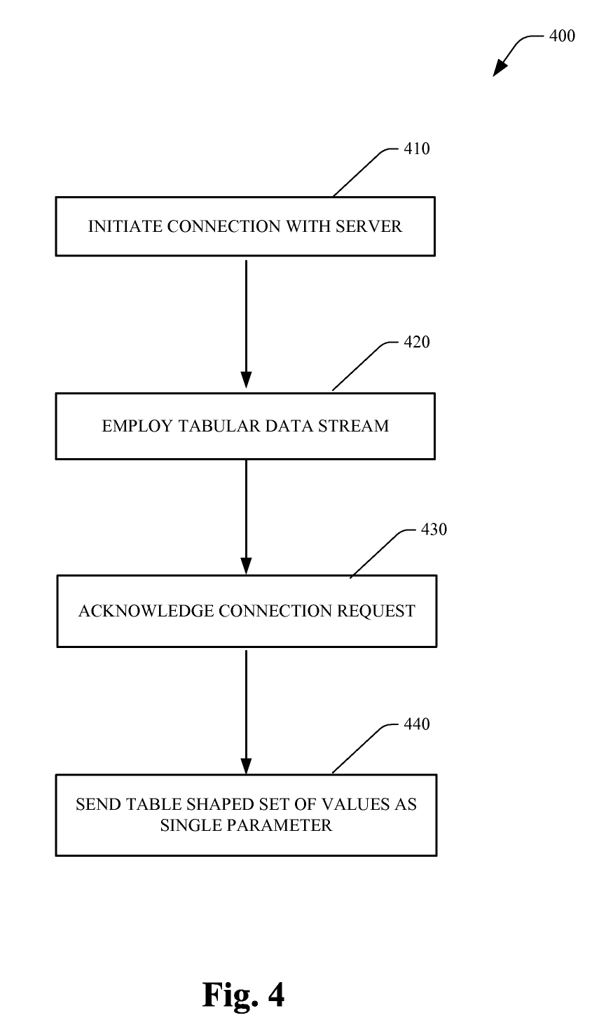

FIG. 4 illustrates a related methodology 400 of sending tabular formed data as a single parameter to servers in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. At 410, a client initiates a connection with the server, via sending a logon data stream on the network, for example (e.g., initiating a hand shake). Such communication from the client to the server can contain multiple commands, and a response from the server can return a plurality of result sets. In such communication initiated, session, presentation, and application service elements are provided by TDS at 420. Next and at 430, the server can acknowledge connection request by the client. Subsequently and at 440, table shaped set of values can be sent as a single parameter from a client to a server—as opposed to merely sending individual values as parameter. For example, the client can send data in form of “N” number of columns and “M” number of rows (where M, N are integers) as a single parameter to a server.

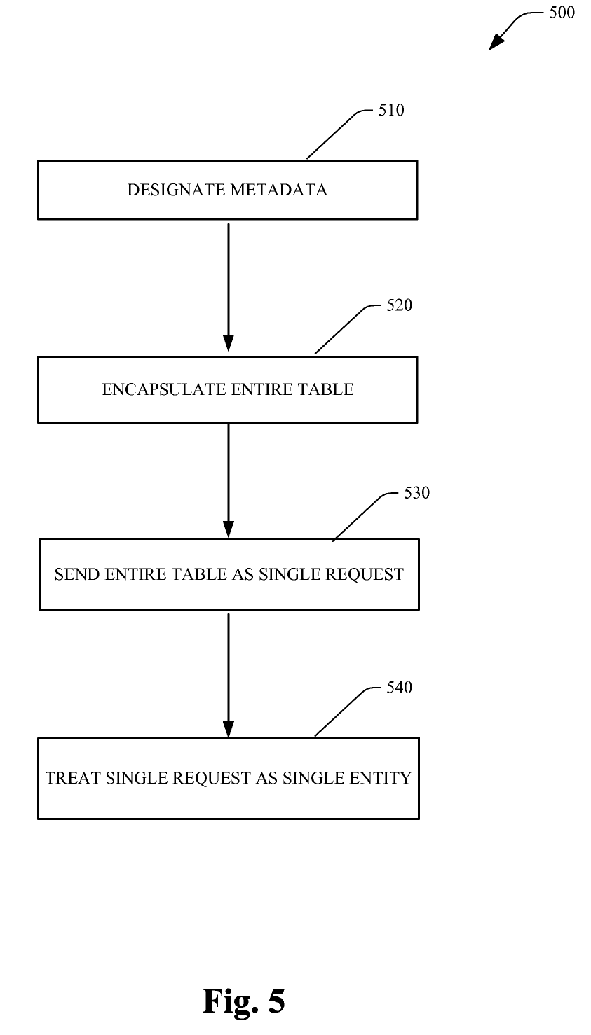

FIG. 5 illustrates a related methodology 500 of encapsulating tables of data via a TVP transporting component of the subject innovation. Initially, and at 510 metadata associated syntax form can be defined, which includes designating syntax for data types/strings, number of rows, number of columns, setting flags to indicate nullable types and the like, as described in detail supra. Next, and at 520, entire table of data can be encapsulated by the TVP transporting component of the subject innovation. Accordingly, table shaped set of values can be sent as a single parameter from a client to a server at 530—as opposed to merely sending individual values as parameter—wherein the client can send data in form of “N” number of columns and “M” number of rows (where M, N are integers) as a single parameter to a server. At 540, the server can subsequently treat such single parameter as a single entity. Associated queries can then be executed on the server side, and results sent back to the client.

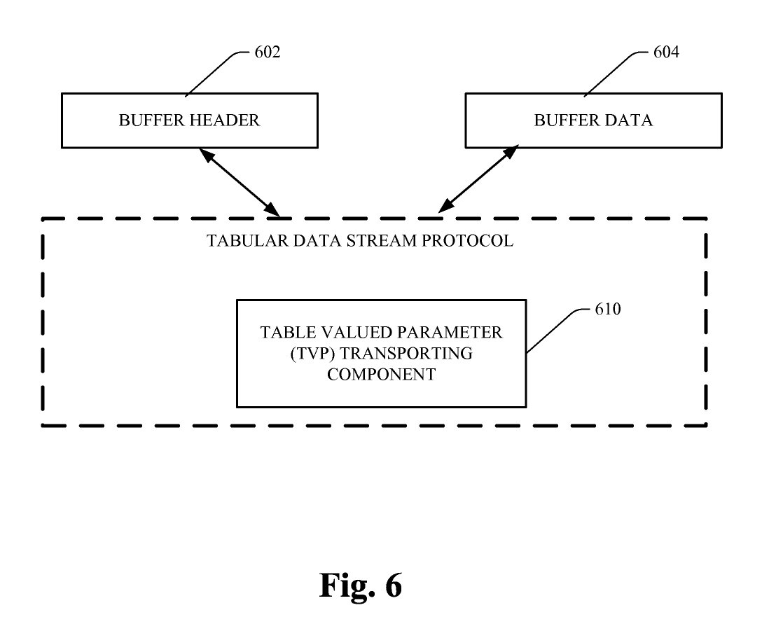

FIG. 6 illustrates an exemplary buffer header arrangement 600 as part of a TVP transporting component 610 that allows client servers to transmit entire database tables as a single parameter. A call from the client to the server can send one or more parameters to the server, wherein a predetermined header portion can define type of value parameter, columns, data types, rows, binary formats and associated buffers.

Typically, the buffer 600 is the unit written or read at one time, and can be modeled as a “packet”, wherein a message can consist of one or more buffers. A buffer can include a buffer header 602, which can be followed by buffer data 604 that contains the message. Moreover, each new message can start in a new buffer.

In general, both the Client and Server attempt to read a buffer full of data, and can pick out the header to observe how much more (or less) data exists in the communication. When the underlying network interface insists on blocking until all bytes specified in the read have been read, the client can read the header and then determine how much more to read. For example, at login time, client can specify a requested “packet” size, which can identify a size employed to break large messages into smaller “packets”. Moreover, messages that pass between client and the server for passing whole tables can typically include one of two types; either a “token stream” or a “tokenless stream”. A token stream consists of one or more “tokens” each followed by some token specific data. A “token” represents a single byte identifier employed to describe data that follows it (e.g. contains token data type, token data length and the like.) Tokenless streams are typically used for simple messages, while messages that can require a more detailed description of the data within it are sent as a token stream.

Exemplary tokens associated with TVP can include the following;

| // | OPTIONAL TVP ADDITIONAL METADATA TOKENS | |
|---|---|---|
| // | | |
| // | TVP_ORDER_UNIQUE definition | |
| // | | |
| | 1. | ColNum ordinals are 1..N (N an integer) where 1 is first |
| | | column in TVP_COLMETADATA (Ordinals start with 1 in other |
| | | words). |
| | 2. | Each TVP_ORDER_UNIQUE token can describe a set of columns |
| | | for ordering and/or a set of columns for uniqueness. |
| | 3. | The first column ordinal with an ordering bit set is the |
| | | primary sort column, the second column ordinal with an |
| | | ordering bit set is the secondary sort column, and so on. |
| | 4. | Client can send 0 or 1 TVP_ORDER_UNIQUE tokens in a single |
| | | TVP. |
| | 5. | The TVP_ORDER_UNIQUE token can be sent after |
| | | TVP_COLMETADATA and before the first TVP_ROW token. |
| | 6. | When a TVP is sent to the server, each ColNum ordinal |
| | | inside a TVP_ORDER_UNIQUE token can refer to a client |
| | | generated column. Ordinals that refer to columns with |
| | | fIdentity or fComputed or fDefault set can be rejected by |
| | | the server. |

| | |
|---|---|
| TVP_ORDER_UNIQUE_TOKEN | := 0x10; |

| | | |
|---|---|---|
| Count | := USHORT; | // Count of ColNums to follow |
| ColNum | := USHORT; | // A single column ordinal |
| fOrderAsc | := BIT; | // Column ordered ascending - |
| 0x01 | | |
| fOrderDesc | := BIT; | // Column ordered descending - |
| 0x02 | | |
| fUnique | := BIT; | // Column is in unique set - |
| 0x04 | | |
| Reserved1 | := BIT, BIT, | // Five reserved bits |
| BIT, BIT, | | |
| BIT; | | |

| | |
|---|---|
| OrderUniqueFlags | := fOrderAsc, fOrderDesc, fUnique, |
| | Reserved1; |
| TVP_ORDER_UNIQUE | := TVP_ORDER_UNIQUE_TOKEN, Count, |
| | {ColNum, OrderUniqueFlags }; |

TABLE 2
OrderUniqueFlags Possible Combinations And Definition

| fOrderAsc | fOrderDesc | fUnique | Definition |
|---|---|---|---|
| FALSE | FALSE | FALSE | Invalid flag state, rejected by server |
| FALSE | FALSE | TRUE | Column is in unique set |
| FALSE | TRUE | FALSE | Column is ordered descending |
| FALSE | TRUE | TRUE | Column is ordered descending and in |
| | | | unique set |
| TRUE | FALSE | FALSE | Column is ordered ascending |
| TRUE | FALSE | TRUE | Column is ordered ascending and in |
| | | | unique set (“in unique set” indicates |
| | | | that the column is a member of |
| | | | a set of 1 . . . N columns that |
| | | | composes a single unique key.) |
| TRUE | TRUE | FALSE | Invalid flag state, rejected by server |
| TRUE | TRUE | TRUE | Invalid flag state, rejected by server |

| | |
|---|---|
| // | TVP_COLUMN_ORDERING |
| // | |

TVP_COLUMN_ORDERING Usage:

| | |
|---|---|
| 1. | TVP_COLUMN_ORDERING is an optional TVP metadata |
| | token used to allow the TDS client to send a different ordering |
| | of the columns in a TVP from the default ordering. |
| 2. | ColNum ordinals are 1..N where 1 is first column in the TVP |
| | (ordinals start with 1 in other words). These are the same |
| | ordinals used with the TDS ORDER token for example to refer |
| | to column ordinal as the columns appear in left to right |
| | order. |
| 3. | Client can send 0 or 1 TVP_COLUMN_ORDERING tokens in |
| | a single TVP. |
| 4. | The TVP_COLUMN_ORDERING token can be sent after |
| | TVP_COLMETADATA and before the first TVP_ROW token. |

TVP_COLUMN_ORDERING_TOKEN := 0x11;

| | | |
|---|---|---|
| Count | := USHORT; | // Count of ColNums |
| to follow | | |
| ColNum | := USHORT; | // A single column |
| ordinal | | |

| | |
|---|---|
| TVP_COLUMN_ORDERING | := |

TVP_COLUMN_ORDERING_TOKEN,
Count,{ColNum};

TVP_COLUMN_ORDERING

TVP_COLUMN_ORDERING is typically employed to re-order the columns in a TVP. For example if a TVP is defined as:
create type myTvp as table (f1 int, f2 varchar(max), f3 datetime)

The TDS client can send the f2 field last inside the TVP as an optimization (streaming the large value last). Accordingly, the client can send TVP_COLUMN_ORDERING with order 1,3,2 to indicate that inside the TVP_ROW section the column f1 is sent first, f3 is sent second, and f2 is send third.

Hence, the TVP_COLUMN_ORDERING token on the wire for the example above can include:

11 // TVP_COLUMN_ORDERING_TOKEN
03 00 // Count - Number of ColNums to follow.
01 00 // ColNum - TVP column ordinal 1 is sent 1^{st} in TVP_ROW.
03 00 // ColNum - TVP column ordinal 3 is sent 2^{nd} in TVP_ROW.
02 00 // ColNum - TVP column ordinal 2 is sent 3^{rd} in TVP_ROW.

Duplicate ColNum values can be considered an error condition. The ordinal values of the columns in the actual TVP type are ordered starting with 1 for the first column and adding one for each column from left to right. The client is required to send one ColNum for each column described in the TVP_COLMETADATA (hence Count should typically match number of columns in TVP_COLMETADATA).

| | |
|---|---|
| // | TVP_ROW definition |
| // | |

TVP_ROW Usage Notes:

| | |
|---|---|
| 1. | Each row will contain one data “cell” per column specified |
| | in TVP_COLMETADATA. On input, columns with the fIdentity |
| | or fDefault or fComputed flags set in TVP_COLMETADATA will |
| | be skipped to avoid sending redundant data. |
| 2. | Column data is ordered in same order as the order of items |
| | defined in TVP_COLMETADATA unless a TVP_COLUMN_ORDERING |
| | token is supplied. |

| TVP_ROW_TOKEN | := 0x01; // A row as defined by TVP_COLMETADATA | |
|---|---|---|
| follows | | |
| TvpColumnData | :=TYPE_VARBYTE; | |
| AllColumnData | :={TvpColumnData}; | // Chunks of data, one per |
| | | // non-default column defined in |
| | | // TVP_COLMETADATA. |

| | |
|---|---|
| TVP_ROW | := TVP_ROW_TOKEN, |
| | AllColumnData; |

// TVP_END_TOKEN definition
//

| | | |
|---|---|---|
| TVP_END_TOKEN | := 0x00; | // Terminator tag for TVP type meaning no |
| more | | |
| | | // TVP_ROWs to follow and end of successful |
| | | // transmission of a single TVP. |

The following discussion provides examples associated with a particular TVP in accordance with an aspect of the subject innovation. Example 1 relates to a sample TVP with 3 columns (int, varchar, datetime) and 4 rows. Ordering is by column ordinal 1 ASC and column ordinal 2 DESC., and Unique index on f1. Accordingly, input TVP data can closely resemble the resultset returned by the following sq1 script:

create table t1 (f1 int, f2 varchar(5), f3 datetime)

go
create unique index idx1 on t1 (f1)
go
insert t1 values (null,null,null)
insert t1 values (1,‘AAAAA’,getdate( ))
insert t1 values (2,‘BBBBB’,getdate( ))
insert t1 values (2,‘CCCCC’,getdate( ))
go
select * from t1 order by 1,2
go
TVP ->

| | |
|---|---|
| 03\|41 00 41 00 41 00 | // ParameterMetaData (parameter name |
| is AAA). | |

| | |
|---|---|
| 00 | // StatusFlags (0 meaning input parameter). |
| F3 | // TVP_TYPE (this is start of |
| TVP_TYPE_INFO). | |

| | |
|---|---|
| 03\|41 00 41 00 41 00 | // DbName - Database where TVP type |
| resides | |
| 03\|42 00 42 00 42 00 | // OwningSchema - Schema for TVP |

| | |
|---|---|
| 03\|43 00 43 00 43 00 | // TypeName - TVP type name |
| 03 00 | // Count - Count of columns to follow. |
| 00 00 00 00 | // UserType |
| 01 00 | // Flags (fNullable) |
| 26 04 | // INTN (4 byte length) |
| 00 | // ColName (0 indicates no name is sent). |
| 00 00 00 00 | // UserType |
| 01 00 | // Flags (fNullable) |

A7 0A 00 09 04 D0 00 34 // BIGVARCHAR (maxlen 10 + collation
0x409 etc)

| | |
|---|---|
| 00 | // ColName |
| 00 00 00 00 | // UserType |
| 01 00 | // Flags (fNullable) |
| 6F 08 | // DATETIMN (length 8) |
| 00 | // ColName |
| 10 | // TVP_ORDER_UNIQUE_TOKEN |
| 02 00 | // Count (2 columns to follow) |
| 01 00 05 (0x01+0x04) | // Column ordinal 1 (1^{st} column ASC and |
| unique) | |
| 02 00 02 | // Column ordinal 2 (2^{nd} column DESC) |
| 00 | // TVP_END_TOKEN (end of optional |
| | metadata) |

| | |
|---|---|
| 01 | // TVP_ROW_TOKEN |
| 00 | // NULL INTN value |
| FF FF | // NULL BIGVARCHAR value |
| 00 | // NULL DATEIMN value |
| 01 | // TVP_ROW_TOKEN |
| 04\|01 00 00 00 | // INTN value (1) |
| 05 00\|41 41 41 41 41 | // BIGVARCHAR value (‘AAAAA’) |
| 08\|90 97 00 00 DF 22 DF 00 | // DATETIMN value (some date) |
| 01 | // TVP_ROW_TOKEN |
| 04\|02 00 00 00 | // INTN value (2) |
| 05 00\|43 43 43 43 43 | // BIGVARCHAR value (‘CCCCC’) |
| 08\|90 97 00 00 DF 22 DF 00 | // DATETIMN value (some date) |
| 01 | // TVP_ROW_TOKEN |
| 04\|02 00 00 00 | // INTN value (2) |
| 05 00\|42 42 42 42 42 | // BIGVARCHAR value (‘BBBBB’) |
| 08\|90 97 00 00 DF 22 DF 00 | // DATETIMN value (some date) |
| 00 | // TVP_END_TOKEN (end of rows) |

// Either start of next ParameterMetaData or end of all
parameters.

### EXAMPLE 2

### Default TVP Sample

In this example, a default TVP is represented, wherein when the client desires to indicate to the server that the entire TVP parameter value is default.

| TVP -> | |
|---|---|
| 03\|41 00 41 00 41 00 | // ParameterMetaData (parameter name is |
| AAA). | |
| 02 | // StatusFlags (2 meaning fDefaultValue). |
| F3 | // TVP_TYPE (this is start of |
| TVP_TYPE_INFO) | |
| 00 | // DbName - Database (sent blank here) |
| 00 | // OwningSchema - Schema (sent blank here) |
| 00 | // TypeName - TVP type name (sent blank |
| here) | |
| FF FF | // 0xFFFF -> TVP_NULL_TOKEN |
| 00 | // TVP_END_TOKEN (end of optional |
| | metadata) |
| 00 | // TVP_END_TOKEN (end of rows) |

// Either start of next ParameterMetaData or end of all
parameters.

### EXAMPLE 3

### Input TVP with a Default Column

This example relates to when the client designates an entire column to be sent to server as default. Server can have default defined on column of TVP, and can further populate value on the server side with predefined default. In general, client will not send any dummy null value (as is send with normal single parameter that is sent as default). For example, such feature can be useful for TVP parameter overloading or for populating a TVP column with a server calculated value, similar to getdate( ) or newid( ).

Accordingly, the following is created and inserted with default values:

create table t2 (f1 varchar(5), f2 datetime default getdate( ))
go
insert t2 values (null,default)
insert t2 values (‘AAAAA’,default)
go
TVP->

| | |
|---|---|
| 03\|41 00 41 00 41 00 | // ParameterMetaData (parameter name is AAA). |
| 00 | // StatusFlags (0 meaning input parameter and |
| | // do not use default value for whole TVP). |
| F3 | // TVP_TYPE (this is start of TVP_TYPE_INFO). |
| 00 | // DbName - Database (not set here). |
| 00 | // OwningSchema - Schema |
| 00 | // TypeName - TVP type name |
| 02 00 | // Count - Count of columns to follow. |
| 00 00 00 00 | // UserType |
| 01 00 | // Flags (fNullable) |
| A7 0A 00 09 04 D0 00 34 | // BIGVARCHAR (maxlen 10 + collation 0x409 etc) |
| 00 | // ColName |
| 00 00 00 00 | // UserType |
| 01 02 | // Flags (fNullable\|fDefault) |
| 6F 08 | // DATETIMN (length 8) |
| 00 | // ColName |
| 00 | // TVP_END_TOKEN (end of optional metadata) |

| | |
|---|---|
| 01 | // TVP_ROW_TOKEN |
| FF FF | // NULL BIGVARCHAR value |
| | // Note NO DATEIMN value sent |
| 01 | // TVP_ROW_TOKEN |
| 05 00\|41 41 41 41 41 | // BIGVARCHAR value (‘AAAAA’) |
| | // Note NO DATEIMN value sent |
| 00 | // TVP_END_TOKEN (end of rows) |

// Either start of next ParameterMetaData or end of all parameters.

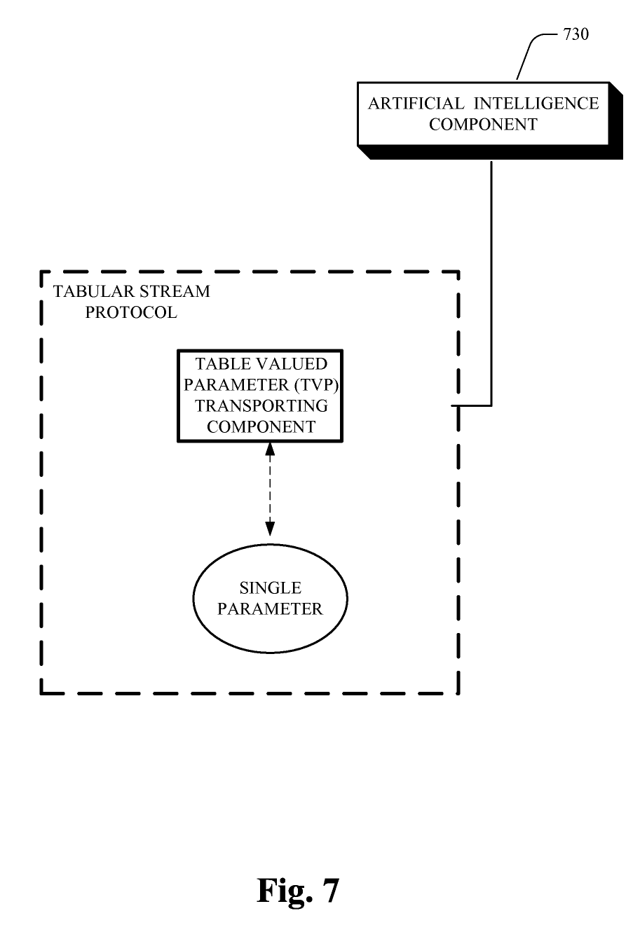

FIG. 7 illustrates an artificial intelligence (AI) component 730 that can be employed to facilitate inferring and/or determining when, where, how to send tabular data by employing a single parameter in accordance with an aspect of the subject innovation. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The AI component 730 can employ any of a variety of suitable AI-based schemes as described supra in connection with facilitating various aspects of the herein described invention. For example, a process for learning explicitly or implicitly how parameters are to be created for sending whole tables can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

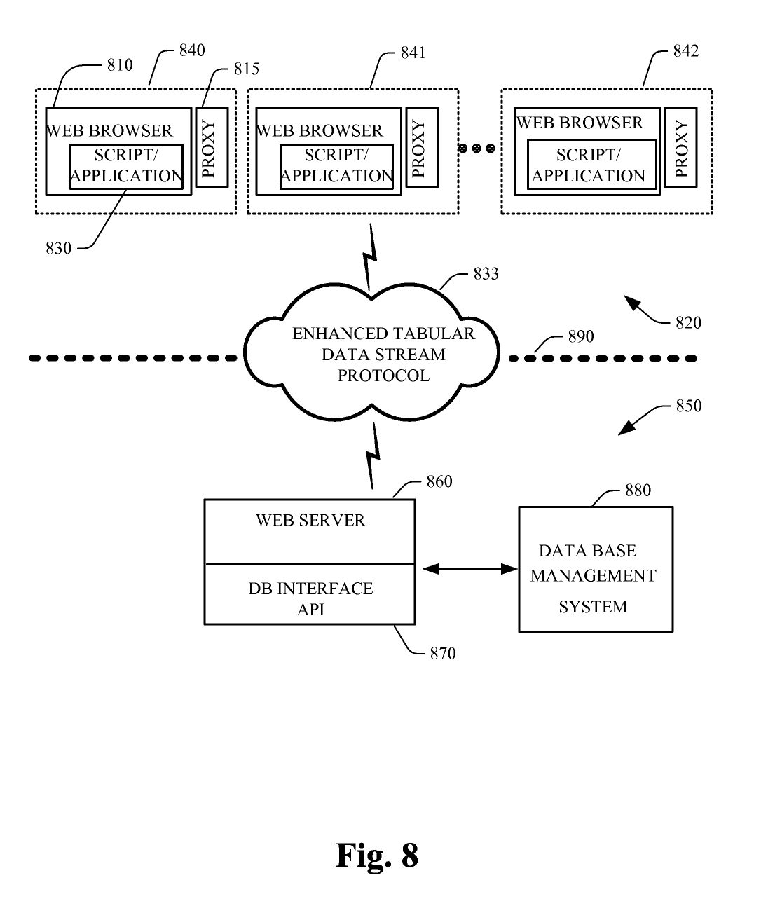

FIG. 8 illustrates a system that implements an enhanced TDS protocol 833 that enables the client 820 to send tabular formed data as single parameter to server 850, wherein running on the client 820 is a client process, for example, a web browser 810. Likewise, running on the server 850 is a corresponding server process, for example, a web server 860. In addition, embedded in the Web Browser 810 can be a script or application 830, and running within the run-time environment 840 of the client computer 820, can exist a proxy 815 for packaging and unpacking data packets formatted in accordance with various aspects of the present invention. Communicating with the server 850 is a database management system (DBMS) 880, which manages access to a database (not shown). The DBMS 880 and the database (not shown) can be located in the server itself, or can be located remotely on a remote database server (not shown). Running on the Web server 860 is a database interface Applications Programming Interface (API) 870, which provides access to the DBMS 880. The client computer 820 and the server computer 850 can communicate with each other through a network 890. When the client process, e.g., the Web browser 810, requests data from a database, the script or application 830 issues a query, which is sent across the network (e.g. internet) 890 to the server computer 850, where it is interpreted by the server process, e.g., the Web server 860. As explained earlier, the client's 820 request to server 850 can contain multiple commands, and a response from server 850 can return a plurality of result sets. In such communication, session, presentation, and application service elements are provided by TDS. Since TDS does not typically require any specific transport provider, it can be implemented over multiple transport protocols and the network 890. Such TDS protocol can employ a Table Valued Parameter (TVP) transporting component 895 that allows client 820 to transmit entire database tables as a single parameter—when invoking a server side procedure, for example.

Responses to client commands that are returned can be self-describing, and record oriented; (e.g. the data streams can describe names, types and optional descriptions of rows being returned.) On the client side 820 the data can be a login record, or a Structured Query Language (SQL) command being in a language that the server side 850 can accept, a SQL command followed by its associated binary data (e.g. the data for a bulk copy command), or an attention signal. When a connection is desired, the client 820 can send a login data stream to the server. Even though the client 820 can have more than one connection to the server 450, each connection path can be established separately and in the same manner.

Once the server 850 has received the login record from the client 820 it will notify the client that it has either accepted or rejected the connection request. Like wise to send SQL command or batch of SQL commands; then the SQL command (e.g. represented by a Unicode format) can be copied into the data section of a buffer and then sent to the SQL Server side 820. A SQL batch may span more than one buffer. In addition, various Open Data Base Connectivity (ODBC) routines can cause SQL command to be placed into a client message buffer, or can cause the message buffer to be sent to the server.

In addition, for an SQL command with binary data, the insert bulk operation can represent a case of a SQL command (e.g. in a Unicode format) followed by binary data. Initially, an insert bulk command can be sent to the server 850 in the normal way, and once an acknowledgment is received from the server 850, the client 820 can then send formatted binary data to the server 850. Such functionality can be provided by routines included in the ODBC, in accordance with one exemplary aspect of the subject innovation. Moreover, the client 820 can initially send an insert bulk SQL statement, followed by a COLMETADATA token, which describes the raw data, followed by Multiple rows of binary data, to the server 850. For example, the data is not formatted in storage engine row format, but rather the format described by the COLMETADATA token. The stream is the same as if the data was being selected from the server 850 rather than being sent to the server 850.

Moreover, a TVP token stream can be named as TVP_ROW, which can be defined by the TVP_COLMETADATA token from client to server or from server to client. Such can include a token value of 0×01/1, having the following Token Stream Specific Rules;

| | |
|---|---|
| TokenType | := BYTE; |

| | |
|---|---|
| TvpColumnData | :=TYPE_VARBYTE; |
| AllColumnData | :={TvpColumnData}; |

| | |
|---|---|
| TVP_ROW | := TokenType, |
| | AllColumnData; |
| [ | |

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

As used in this application, the terms “component”, “system”, “engine” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

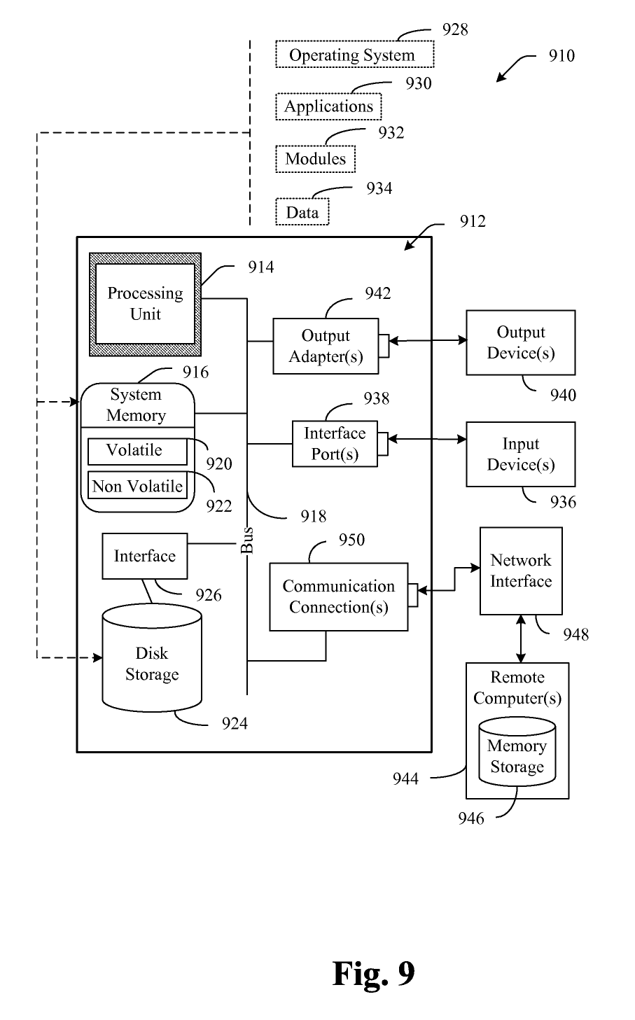

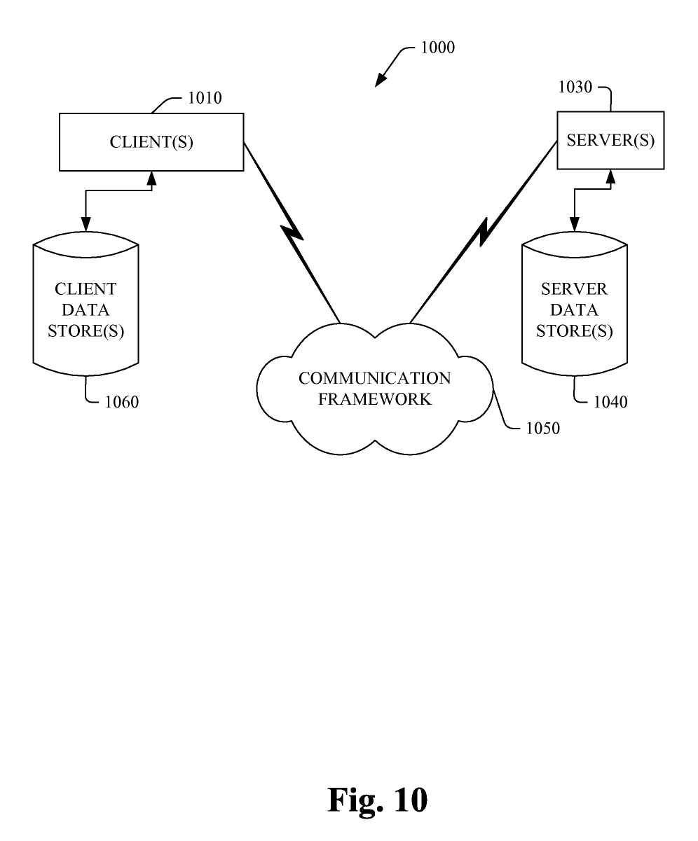

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed for implementing the enhanced TDS of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
a tabular data stream (TDS) protocol that transfers requests-responses between a client(s) and a server(s)
a table valued parameter (TVP) transporting component as part of the TDS, the TVP component sends tabular formed data as a single parameter from the client to the server.

2. The computer implemented system of claim 1, the TDS protocol further comprising value parameters that define the tabular formed data.

3. The computer implemented system of claim 2, the TDS protocol further comprising a buffer modeled as a packet for transfer of the tabular formed data.

4. The computer implemented system of claim 2 further comprising stored procedures invocable by the server for transfer of the tabular formed data.

5. The computer implemented system of claim 4 further comprising a parameter styled Application Program Interface (API) that passes values for functions associated with the stored procedures.

6. The computer implemented system of claim 4 further comprising a database management system associated with relational databases.

7. The computer implemented system of claim 4, the client further comprising a Web Browser

8. The computer implemented system of claim 7, the tabular formed data represents a whole table.

9. The computer implemented system of claim 7 further comprising Open Data Base Connectivity (ODBC) routines to place SQL commands into a message buffer of the client.

10. The computer implemented system of claim 7, the SQL commands in Unicode format.

11. A computer implemented method comprising the following computer executable acts:
transferring data from a client to a server via a TDS protocol; and
sending a tabular formed data as a single parameter from the client to the server.

12. The computer implemented method of claim 11 further comprising encapsulating an entire table of data.

13. The computer implemented method of claim 11 further comprising setting flags to indicate nullable types.

14. The computer implemented method of claim 11 further comprising defining rows or columns or data types or a combination thereof by a header portion.

15. The computer implemented method of claim 11 further comprising employing tokens in form of single byte identifiers.

16. The computer implemented method of claim 15 further comprising describing ordering of columns.

17. The computer implemented method of claim 16 further comprising treating the single parameter as a single entity.

18. The computer implemented method of claim 11 further comprising inferring generation of the single parameter via classifiers.

19. The computer implemented method of claim 11 further comprising sending tables inside of the single parameter to SQL servers.

20. A computer implemented system comprising:
means for exchanging data between a client and a server; and
means for receiving a table by the server in form of a single parameter.
